(19) United States
(12) Patent Application Publication
(10) Pub. No.: US 2025/0314269 A1
(43) Pub. Date: Oct. 9, 2025

(54) EXTERNALLY PRESSURIZED JOURNAL BEARING AND METHOD FOR FABRICATING THEREOF

(71) Applicant: Industry-University Cooperation Foundation Hanyang University Erica Campus, Ansan-si (KR)

(72) Inventors: Keun RYU, Seoul (KR); Jun Won HEO, Ansan-si (KR)

(21) Appl. No.: 19/243,032

(22) Filed: Jun. 19, 2025

Related U.S. Application Data
(63) Continuation of application No. PCT/KR2024/095084, filed on Feb. 6, 2024.

(30) Foreign Application Priority Data
Feb. 10, 2023 (KR) 10-2023-0017791
Oct. 24, 2023 (KR) 10-2023-0142569

(51) Int. Cl. F16C 32/06; B33Y 10/00; B33Y 80/00

(52) U.S. Cl. CPC F16C 32/0666; F16C 32/0618; F16C 32/0677; B33Y 10/00; B33Y 80/00

(57) ABSTRACT

Provided is an externally pressurized journal bearing comprising: a bearing sleeve mounted in a ring-engaged manner on the outer diameter surface of a rotating shaft; bearing pads provided on the inner diameter surface of the bearing sleeve, having gaps in the circumferential direction on the inner diameter surface, and supporting the rotating shaft in the radial direction through a bearing surface facing the rotating shaft; and a bearing web provided between the bearing sleeve and the bearing pads, formed integrally with the bearing sleeve and the bearing pad, and flexible to enable tilting of the bearing pad, wherein at least one side of the bearing pad is provided as a porous component, and a working fluid supplied from the side of the bearing sleeve and passing through the bearing sleeve and the bearing web is guided through the porous component to the bearing surface.

### TECHNICAL FIELD

The present invention relates to an externally pressurized journal bearing and a method of manufacturing the same, and more particularly, to an externally pressurized journal bearing capable of exhibiting high load bearing capacity and rigidity and excellent rotor dynamic stability and reliability, and a method of manufacturing the externally pressurized journal bearing.

### BACKGROUND ART

Recently, as the demand for ultra-high-speed rotary machines that may be operated in extreme operating environments increases in the industrial fields related to energy, propulsion, and power, high-performance and high-efficiency fluid bearing technology is receiving great attention.

This is because bearings play a very important role in the development and operation of high-speed and high-efficiency turbine, compressor, and pump systems. In particular, externally pressurized bearings and foil bearings that use working fluids as lubricants are currently receiving great attention in the field of fluid bearing technology, and many global companies are continuously investing in the development of products to which the externally pressurized bearings and the foil bearings are applied.

The externally pressurized bearing is configured such that a high-pressure working fluid is supplied from an outside to a lubricating surface of the bearing, so that high load bearing capacity and high rigidity may be ensured, and friction and abrasion between a shaft and the bearing may be minimized even in the absence of relative motion.

Conventional externally pressurized bearings are configured such that a plurality of orifices are provided inside the bearing. Characteristics of the externally pressurized bearing vary greatly depending on dimensions of the orifice.

However, when the externally pressurized bearing is manufactured by a metal stacking manufacturing scheme, it is very difficult to precisely form an orifice having very small dimensions in a limited inner space of the bearing.

As a result, metal powder may remain in an inner flow path of the orifice formed through the metal stacking manufacturing scheme, and the orifice may be clogged due to the metal powder remaining in the inner flow path of the orifice as described above.

### DISCLOSURE

### Technical Problem

One technical object to be achieved by the present invention is to provide an externally pressurized journal bearing capable of exhibiting high load bearing capacity and rigidity and excellent rotor dynamic stability and reliability, and a method of manufacturing the externally pressurized journal bearing.

Technical objects to be achieved by the present invention are not limited to the technical objects described above.

### Technical Solution

To achieve the technical objects described above, the present invention provides an externally pressurized journal bearing.

According to one embodiment, the externally pressurized journal bearing includes: a bearing sleeve mounted in a ring-engaged manner on an outer diameter surface of a rotating shaft; a plurality of bearing pads provided on an inner diameter surface of the bearing sleeve, arranged with a gap in a circumferential direction on the inner diameter surface of the bearing sleeve, and configured to support the rotating shaft in a radial direction through a bearing surface facing the rotating shaft; and a bearing web provided between the bearing sleeve and the bearing pad, formed integrally with the bearing sleeve and the bearing pad, and having flexibility so as to enable tilting of the bearing pad, wherein at least one side of the bearing pad is provided as a porous component, and a working fluid supplied from a side of the bearing sleeve side and passing through the bearing sleeve and the bearing web is guided to the bearing surface through the porous component, and discharged at high pressure from the bearing surface toward the rotating shaft by the porous component.

According to one embodiment, formation energy density of the porous component may be 5 J/mm³ to 13 J/mm³.

According to one embodiment, under identical supply pressure of the working fluid, in a case where the formation energy density is greater or equal to 11 J/mm³, the porous component may have a flow rate that is at least twice as large as a flow rate in a case where the formation energy density is greater or equal to 8 J/mm³.

According to one embodiment, the formation energy density of the porous component may be 11 J/mm³ to 13 J/mm³.

According to one embodiment, the porous component may have a relatively large flow rate under identical supply pressure of the working fluid as the formation energy density increases.

According to one embodiment, the bearing sleeve may include: a sleeve body having a center that is open in an axial direction so as to allow insertion of the rotating shaft; and a slot provided inside the sleeve body so as to correspond to each of the bearing pads, and configured to allow both axial ends of the sleeve body to communicate with each other.

According to one embodiment, the externally pressurized journal bearing may further include: a damper, wherein the damper may be installed in the slot, and configured to support the bearing pad in the radial direction.

According to one embodiment, the externally pressurized journal bearing may further include: a working fluid supply line, wherein the working fluid supply line may include: a first supply line provided inside the bearing sleeve; a second supply line connected to the first supply line, and provided inside the bearing web; and a third supply line provided inside the bearing pad, and connecting the second supply line to the porous component.

According to one embodiment, the first supply line may include: a pocket formed on an outer diameter surface of the bearing sleeve; and a first fluid passage connected to the pocket, extending in one direction, and provided to correspond to each of the bearing pads.

According to one embodiment, the second supply line may include a second fluid passage branching from one longitudinal side of the first fluid passage toward the third supply line.

According to one embodiment, the third supply line may include: a plurality of third-first fluid passages branching from a longitudinal end of the second fluid passage; and a third-second fluid passage extending in a surface direction of the bearing pad, and connected between a rear end of the porous component and longitudinal ends of the branching third-first fluid passages.

Meanwhile, the present invention provides a method of manufacturing an externally pressurized journal bearing.

According to one embodiment, the method of manufacturing the externally pressurized journal bearing includes: integrally forming, through 3D printing, a bearing sleeve mounted in a ring-engaged manner on an outer diameter surface of a rotating shaft, a plurality of bearing pads provided on an inner diameter surface of the bearing sleeve, arranged with a gap in a circumferential direction on the inner diameter surface of the bearing sleeve, and configured to support the rotating shaft in a radial direction through a bearing surface facing the rotating shaft, and a bearing web provided between the bearing sleeve and the bearing pad, and having flexibility so as to enable tilting of the bearing pad, wherein, in the integrally forming, a porous component is formed on at least one side of the bearing pad by controlling energy density to be lower than reference energy density.

According to one embodiment, formation energy density of the porous component may be 5 J/mm³ to 13 J/mm³.

According to one embodiment, in the integrally forming, a scanning speed may be controlled to 2,800 mm/s to 6,200 mm/s, and a laser power may be controlled to 160 J/s to 180 J/s.

### Advantageous Effects

According to an embodiment of the present invention, the externally pressurized journal bearing may include: a bearing sleeve mounted in a ring-engaged manner on an outer diameter surface of a rotating shaft; a plurality of bearing pads provided on an inner diameter surface of the bearing sleeve, arranged with a gap in a circumferential direction on the inner diameter surface of the bearing sleeve, and configured to support the rotating shaft in a radial direction through a bearing surface facing the rotating shaft; and a bearing web provided between the bearing sleeve and the bearing pad, formed integrally with the bearing sleeve and the bearing pad, and having flexibility so as to enable tilting of the bearing pad, wherein at least one side of the bearing pad is provided as a porous component, and a working fluid supplied from a side of the bearing sleeve side and passing through the bearing sleeve and the bearing web is guided to the bearing surface through the porous component, and discharged at high pressure from the bearing surface toward the rotating shaft by the porous component.

As described above, according to the embodiment of the present invention, since an orifice having accurate dimensions is not applied to a bearing surface, a degree of design freedom and manufacturing ease of the bearing can be significantly improved, so that load bearing capacity, rigidity, rotor dynamic stability, and reliability can be improved.

In addition, according to the embodiment of the present invention, instead of pressurizing the working fluid into the bearing through an orifice, the porous component having a porous structure may be provided to the bearing pad, so that an orifice clogging problem that have occurred upon manufacture by a metal stacking manufacturing scheme and limitations in implementing accurate dimensions of the orifice can be fundamentally resolved.

In other words, according to the embodiment of the present invention, since the at least one side of the bearing pad is provided as the porous component, an externally pressurized journal bearing having excellent performance can be provided.

### DESCRIPTION OF DRAWINGS

FIG. 1 is a perspective view showing an externally pressurized journal bearing according to one embodiment of the present invention.

FIG. 2 is a plan view of FIG. 1.

FIG. 3 is a front view of FIG. 1.

FIGS. 4 to 8 are schematic diagrams for describing the externally pressurized journal bearing according to one embodiment of the present invention.

FIG. 9 is a schematic diagram for describing an externally pressurized journal bearing according to a modified example of the present invention.

FIG. 10 is a flowchart showing a method of manufacturing an externally pressurized journal bearing according to one embodiment of the present invention.

FIG. 11 and FIG. 12 are photographs showing porous component samples manufactured according to Example 1.

FIG. 13 and FIG. 14 are photographs showing porous component samples manufactured according to Example 2.

### MODE FOR INVENTION

Hereinafter, exemplary embodiments of the present invention will be described in detail with reference to the accompanying drawings. However, the technical idea of the present invention is not limited to the embodiments described herein, but may be embodied in different forms. The embodiments introduced herein are provided to sufficiently deliver the idea of the present invention to those skilled in the art so that the disclosed contents may become thorough and complete.

When it is mentioned in the present disclosure that one element is on another element, it means that one element may be directly formed on another element, or a third element may be interposed between one element and another element. Further, in the drawings, shapes and sizes are exaggerated for effective description of the technical contents.

In addition, although the terms such as first, second, and third have been used to describe various elements in various embodiments of the present disclosure, the elements are not limited by the terms. The terms are used only to distinguish one element from another element. Therefore, an element mentioned as a first element in one embodiment may be mentioned as a second element in another embodiment. The embodiments described and illustrated herein include their complementary embodiments, respectively. Further, the term “and/or” used in the present disclosure is used to include at least one of the elements enumerated before and after the term.

As used herein, an expression in a singular form includes a meaning of a plural form unless the context clearly indicates otherwise. Further, the terms such as “including” and “having” are intended to designate the presence of features, numbers, steps, elements, or combinations thereof described herein, and shall not be construed to preclude any possibility of the presence or addition of one or more other features, numbers, steps, elements, or combinations thereof. In addition, the term “connection” used herein is used to include both indirect and direct connections of a plurality of elements.

Further, in the following description of the present invention, detailed descriptions of known functions or configurations incorporated herein will be omitted when they may make the gist of the present invention unnecessarily unclear.

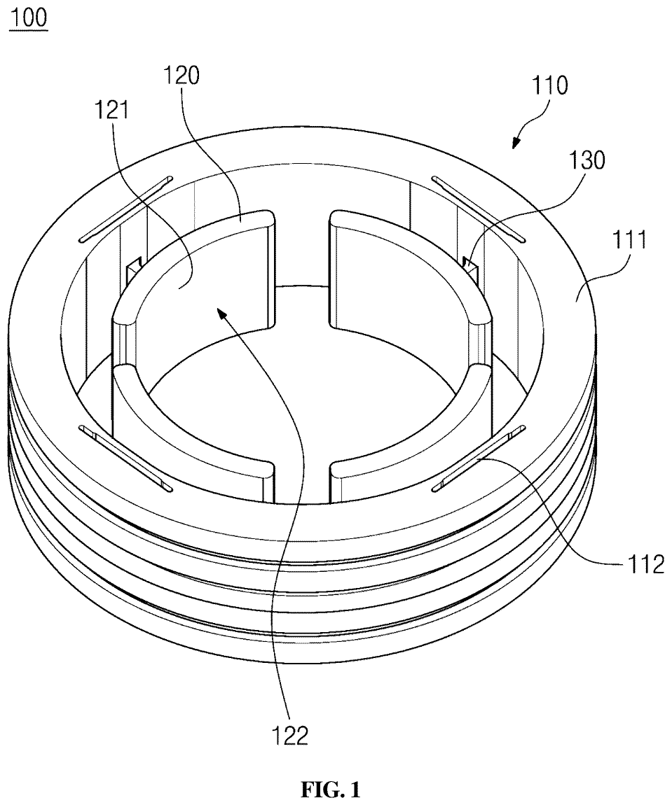

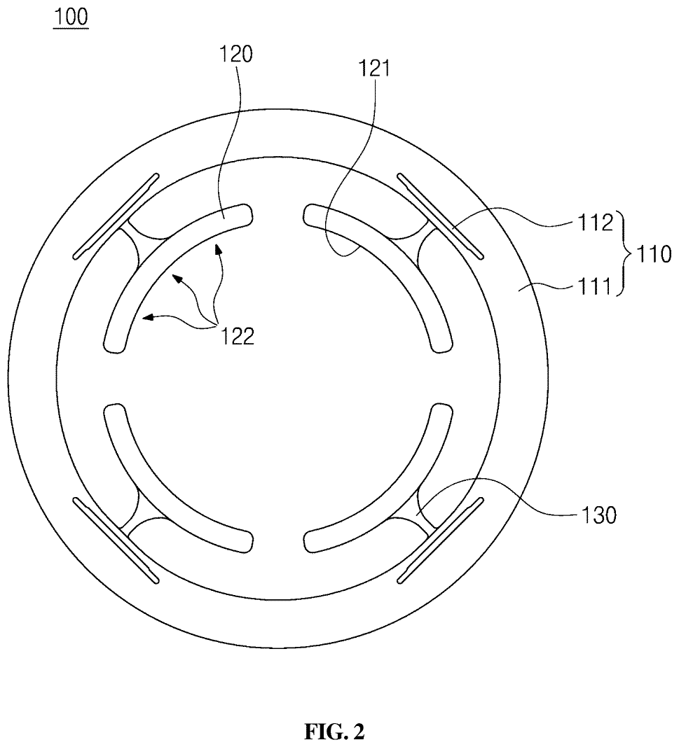

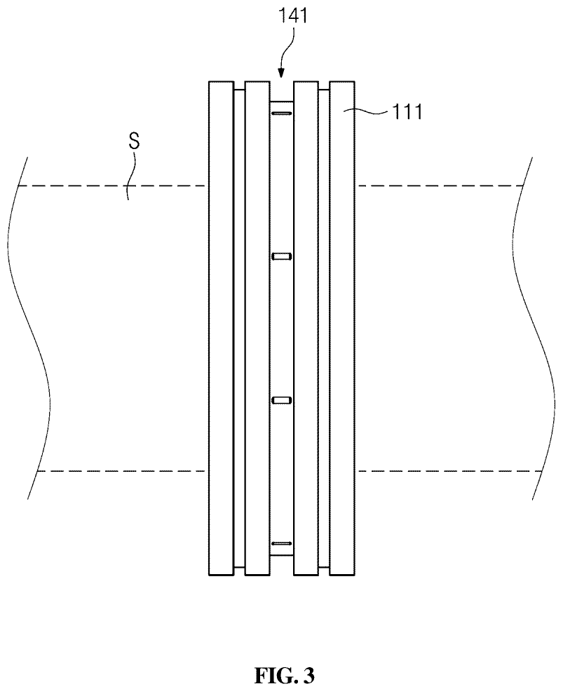

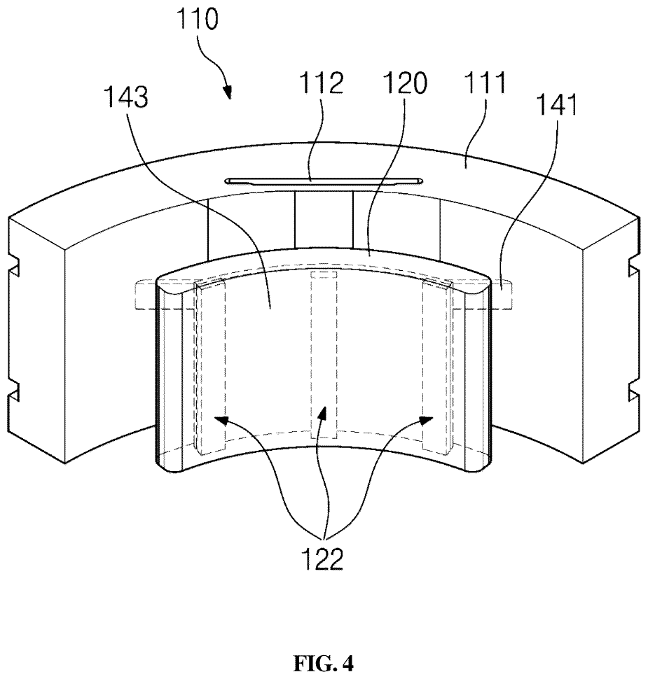

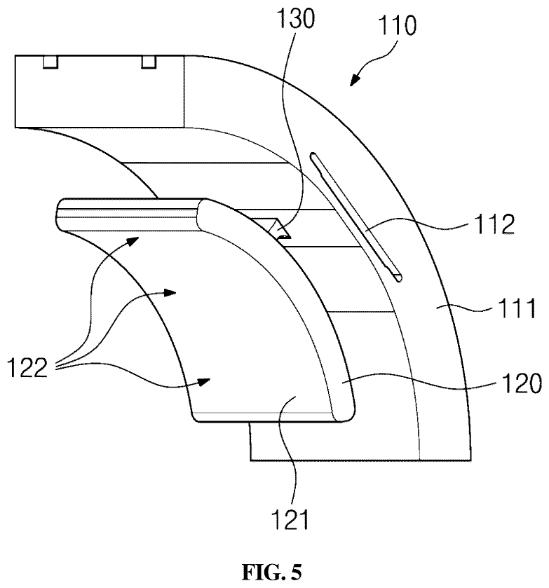

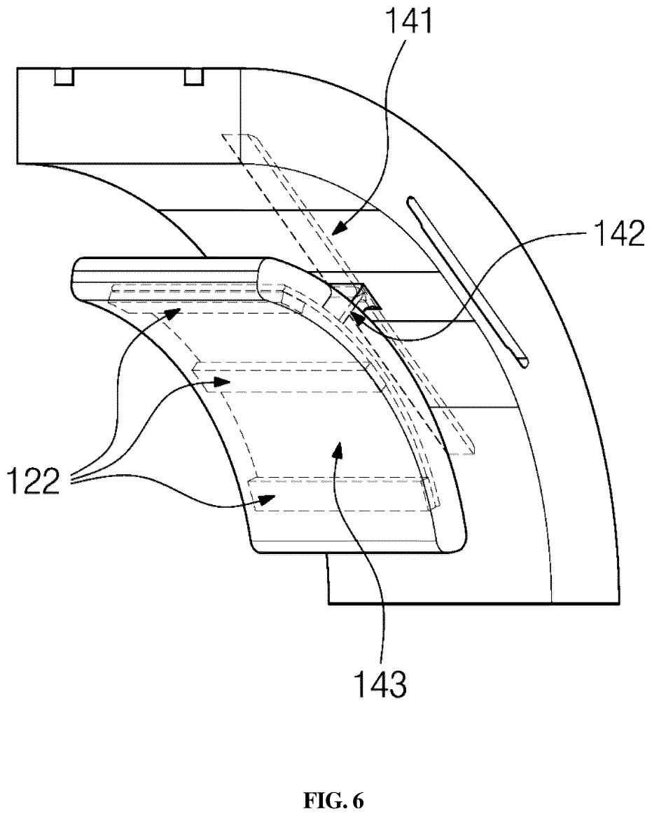

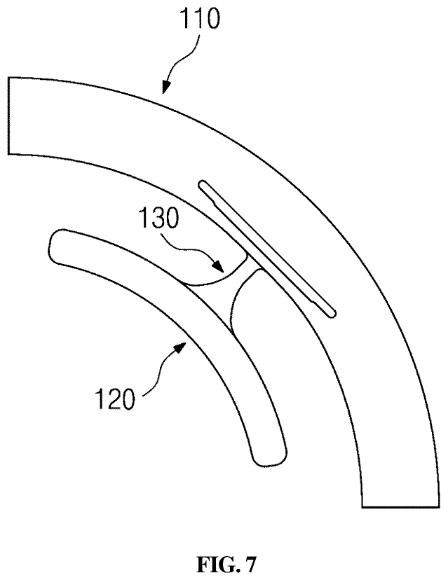

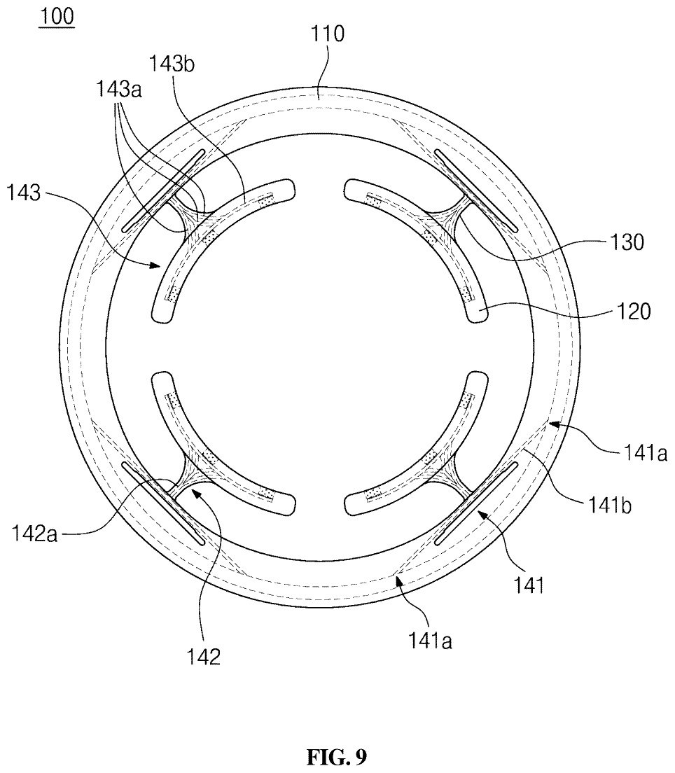

FIG. 1 is a perspective view showing an externally pressurized journal bearing according to one embodiment of the present invention, FIG. 2 is a plan view of FIG. 1, FIG. 3 is a front view of FIG. 1, FIGS. 4 to 8 are schematic diagrams for describing the externally pressurized journal bearing according to one embodiment of the present invention, and FIG. 9 is a schematic diagram for describing an externally pressurized journal bearing according to a modified example of the present invention.

As shown in FIGS. 1 to 3, an externally pressurized journal bearing 100 according to one embodiment of the present invention may be a bearing for supporting a radial load of a rotary machine, and may be mounted on an outer diameter surface of a rotating shaft S provided in a rotary machine, for example, a turbine, a compressor, a pump, or the like. The externally pressurized journal bearing 100 according to one embodiment of the present invention may discharge a high-pressure working fluid toward the rotating shaft S so as to support a rotational movement of the rotating shaft S.

To this end, the externally pressurized journal bearing 100 according to one embodiment of the present invention may include a bearing sleeve 110, a bearing pad 120, and a bearing web 130.

The bearing sleeve 110 may be mounted in a ring-engaged manner on the outer diameter surface of the rotating shaft S provided in the rotary machine. The bearing sleeve 110 may be connected to the bearing pad 120 via the bearing web 130.

Accordingly, the bearing sleeve 110 may support the bearing pad 120 arranged between the bearing sleeve 110 and the rotating shaft S.

According to one embodiment of the present invention, the bearing sleeve 110 may include a sleeve body 111 and a slot 112.

The sleeve body 111 may form an exterior of the bearing sleeve 110. The sleeve body 111 may have a center that is open in an axial direction so as to allow insertion of the rotating shaft S.

In this case, the sleeve body 111 may have an inner diameter in which the bearing pad 120 and the bearing web 130 may be arranged between the sleeve body 111 and the rotating shaft S.

Accordingly, when the bearing sleeve 110 is mounted in the ring-engaged manner on the outer diameter surface of the rotating shaft S, a gap having a ring shape may be formed in a circumferential direction between an inner diameter surface of the sleeve body 111 and the outer diameter surface of the rotating shaft S, and the bearing pad 120 and the bearing web 130 may be arranged in the gap.

The slot 112 may be provided inside the sleeve body 111. In this case, the slot 112 may be provided inside the sleeve body 111 so as to correspond to each of a plurality of bearing pads 120.

In other words, according to one embodiment of the present invention, the number of slots 112 may correspond to the number of bearing pads 120.

Accordingly, a plurality of slots 112 may be provided inside the sleeve body 111, and the slots 112 may be provided in the circumferential direction of the sleeve body 111 so as to correspond to the bearing pads 120, respectively.

Although four bearing pads 120 and thus four slots 112 have been illustrated in one embodiment of the present invention as being provided, this is only an example, so that the number of bearing pads 120 may vary according to design purposes, and the number of slots 112 may correspond to the number of bearing pads 120 provided.

According to one embodiment of the present invention, the slots 112 may be provided inside the sleeve body 111 so as to allow both axial ends of the sleeve body 111 to communicate with each other.

Meanwhile, although not shown in the drawings, the externally pressurized journal bearing 100 according to one embodiment of the present invention may further include a damper.

According to one embodiment of the present invention, the damper may be a compliant damper, and may be installed in the slot 112.

According to one embodiment of the present invention, since the slots 112 are provided in the circumferential direction of the sleeve body 111 such that the number of slots 112 may correspond to the number of bearing pads 120, a plurality of dampers may also be provided such that the number of dampers may correspond to the number of slots 112.

In other words, the dampers may be located on radial outer sides corresponding to the bearing pads 120 so as to support the bearing pads 120 in a radial direction, respectively.

Accordingly, each of the bearing pads 120 may move freely in the radial direction according to a radial load by the damper located on the radial outer side.

This may enable ensuring a minimum oil film thickness for lubrication of the externally pressurized journal bearing 100 even under extreme operating conditions, so that marginal performance of the externally pressurized journal bearing 100 may be improved.

For example, the damper may be provided as a bump-type spring damper. The bump-type spring damper may provide damping force by frictional force generated during a deformation process of a bump as well as support the bearing pad 120 due to the radial load.

Therefore, the bump-type spring damper may allow the externally pressurized journal bearing 100 to have high rigidity and damping force.

As described above, the damping force that is additionally provided by the bump-type spring damper may ensure stability of the rotary machine in an operating environment where a large dynamic load occurs in the radial direction of the rotating shaft S, and avoid damage to the externally pressurized journal bearing 100.

In this case, the rigidity and the damping force of the externally pressurized journal bearing 100 may be tuned through design changes in a bump shape of the spring damper, for example, a height, an interval, a thickness, or the like of the bump.

Referring further to FIGS. 4 to 7, the bearing pad 120 may be provided on the inner diameter surface of the bearing sleeve 110.

When the externally pressurized journal bearing 100 according to one embodiment of the present invention is mounted on the rotating shaft S of the rotary machine, the bearing pad 120 may face the outer diameter surface of the rotating shaft S of the rotary machine.

According to one embodiment of the present invention, a plurality of bearing pad 120 may be provided. The bearing pads 120 may be arranged with a gap in the circumferential direction on the inner diameter surface of the bearing sleeve 110. In this case, the bearing pads 120 may have the same shape and size.

Although four bearing pads 120 arranged with the gap in the circumferential direction on the inner diameter surface of the bearing sleeve 110 have been illustrated in one embodiment of the present invention, this is only an example, so that the number of bearing pads 120 formed in the present invention is not specifically limited. In other words, the number of bearing pads 120 formed may be adjusted to vary according to bearing design, performance, operating conditions and environments, and the like.

The bearing pad 120 may be supported by the bearing web 130, and separated from the bearing sleeve 110 through the bearing web 130.

According to one embodiment of the present invention, the bearing pad 120 may have a bearing surface 121 defined as a surface facing the outer diameter surface of the rotating shaft S. The bearing pad 120 may support the rotating shaft S of the rotary machine in the radial direction through the bearing surface 121.

The bearing pad 120 may be provided in a plate shape having a thickness in the radial direction. In this case, the bearing surface 121 facing the rotating shaft S of the rotary machine may be formed as a concave curved surface having the same curvature as the inner diameter surface of the bearing sleeve 110, and a rear surface of the bearing pad 120, which is opposite to the bearing surface 121, may be formed as a convex curved surface having the same curvature as the inner diameter surface of the bearing sleeve 110.

Meanwhile, according to one embodiment of the present invention, at least one side of the bearing pad 120 may be provided as a porous component 122 having a porous structure.

As shown in FIG. 4, the porous component 122 may be provided in the axial direction on both edge sides and a center of the bearing pad 120.

However, this is only an example, so that the number, locations, sizes, shapes, and the like of porous components 122 provided in the present invention are not specifically limited. In other words, numbers, locations, sizes, and shapes of the porous components 122 provided to the bearing pad 120 may vary according to design purposes and the like.

According to one embodiment of the present invention, the porous component 122 may be provided in a depthwise direction of the bearing surface 121, and in this case, an end portion of the porous component 122 may be exposed to the bearing surface 121.

The porous component 122 may be connected to a working fluid supply line that will be described below.

Accordingly, a working fluid supplied from a side of the bearing sleeve 110 and passing through the bearing sleeve 110 and the bearing web 130 may be guided to the bearing surface 121 through the porous component 122.

In other words, according to one embodiment of the present invention, the porous component 122 may serve as a passage for guiding the working fluid.

In addition, the working fluid guided to the bearing surface 121 through the porous component 122 may be discharged at high pressure from the bearing surface 121 toward the rotating shaft S of the rotary machine by the porous component 122.

In other words, according to one embodiment of the present invention, the porous component 122 may serve as a discharge port for the working fluid.

As described above, the porous component 122 having the porous structure may replace a conventional orifice.

Characteristics of the externally pressurized journal bearing may vary greatly depending on dimensions of the orifice. When the externally pressurized journal bearing is manufactured by a metal stacking manufacturing scheme, it is difficult to precisely form an orifice having very small dimensions in a limited space of the bearing. Therefore, metal powder may remain in an inner flow path of the formed orifice, and the orifice may be clogged due to the remaining metal powder.

Accordingly, according to one embodiment of the present invention, there may be provided the porous component 122 having the porous structure, capable of fundamentally resolving the problem associated with the conventional orifice.

In other words, according to one embodiment of the present invention, since the porous component 122 replaces an orifice requiring accurate dimensions, a degree of design freedom and manufacturing ease of the bearing may be significantly improved, so that load bearing capacity, rigidity, rotor dynamic stability, and reliability may be improved.

According to one embodiment of the present invention, the porous component 122 having the porous structure may be provided as a combination of innumerable holes. Accordingly, the working fluid may be evenly supplied to the bearing surface 121 through the porous component 122 provided as the combination of innumerable holes.

The porous component 122 may be provided as a combination of innumerable holes that are invisible to eyes, for example, innumerable holes having sizes of several micrometers.

Accordingly, for example, even when some of the innumerable holes are clogged, an influence of the clogging on the discharge of the working fluid may be insignificant.

In other words, even when some of the innumerable holes are clogged, the working fluid may be discharged smoothly, so that a performance degradation problem of the externally pressurized journal bearing 100 may not occur, or may be minimized even when the performance degradation problem occurs.

As described above, according to one embodiment of the present invention, instead of a conventional method of pressurizing the working fluid into the bearing through an orifice, the porous component 122 having the porous structure may be provided on the at least one side of the bearing pad 120, so that an orifice clogging problem that have occurred upon manufacture by the metal stacking manufacturing scheme and limitations in implementing accurate dimensions of the orifice may be fundamentally resolved.

In this case, the conventional orifice may have, for example, a diameter of 0.5 mm, whereas the holes of the porous component 122 may have sizes of several μm, so that discharge pressure of the working fluid may be further increased, and thus the load bearing capacity may be greatly improved.

The performance of the porous component 122 may be determined by energy density, which is an amount of laser energy that is input per unit volume (mm³) upon manufacture by the metal stacking manufacturing scheme, that is, 3D printing.

According to one embodiment of the present invention, formation energy density of the porous component 122 may be 5 J/mm³ to 13 J/mm³.

In this case, under identical supply pressure of the working fluid, in a case where the formation energy density is greater or equal to 11 J/mm³, the porous component 122 may have a flow rate that is at least twice as large as a flow rate in a case where the formation energy density is greater or equal to 8 J/mm³.

In other words, the porous component 122 may have a relatively larger flow rate in a case where the formation energy density is 11 J/mm³ to 13 J/mm³ than in a case where the formation energy density is less than or equal to the former case.

In addition, the porous component 122 may have a relatively large flow rate under identical supply pressure of the working fluid as the formation energy density increases in the case where the formation energy density is 11 J/mm³ to 13 J/mm³.

In other words, upon manufacture of the externally pressurized journal bearing 100 by the 3D printing, which is the metal stacking manufacturing scheme, when the energy density is controlled to 35.3 J/mm³ to 37.49 J/mm³, and lowered to 11 J/mm³ to 13 J/mm³, the porous component 122 having a large flow rate and having a porous structure including a combination of micrometer-sized holes may be formed on the bearing pad 120.

The bearing web 130 may be provided between the bearing sleeve 110 and the bearing pad 120. According to one embodiment of the present invention, the bearing web 130 may be provided to correspond to each of the bearing pads 120.

In other words, the bearing web 130 may be provided on a rear side of each of the bearing pads 120 so as to allow the bearing sleeve 110 and the bearing pad 120 to be spaced apart from each other, and so as to support the bearing pad 120 on the bearing sleeve 110.

In addition, according to one embodiment of the present invention, the bearing web 130 may be provided in the form of a beam having flexibility.

The bearing web 130 may form a sectional structure having approximately an ‘H’ shape with the bearing sleeve 110 and the bearing pad 120.

According to one embodiment of the present invention, a plurality of bearing webs 130 having flexibility and provided in the form of beams may be provided in the circumferential direction of the bearing sleeve 110 between the bearing sleeve 110 and the bearing pad 120.

As described above, when the bearing pad 120 is supported by the bearing web 130 in the form of a flexible beam, the bearing pad 120 may be tilted according to bearing operating conditions. In other words, the bearing pad 120 supported by the bearing web 130 having flexibility may actively move according to changes such as a static or dynamic load and tilting and expansion of the rotating shaft S.

Accordingly, the externally pressurized journal bearing 100 according to one embodiment of the present invention may have very high rotor dynamic stability, and may maintain reliable performance even under extreme operating conditions.

Meanwhile, conventionally, a bearing web was coupled to a bearing sleeve by using a bond or through press-fit, in which the bond coupling had a problem of being unable to withstand high temperatures, and the press-fit coupling had a deformation issue caused by thermal expansion coefficients of the bearing sleeve and the bearing web.

In order to solve the above problems, according to one embodiment of the present invention, the bearing sleeve 110, the bearing pad 120, and the bearing web 130 may be integrally formed.

In other words, the externally pressurized journal bearing 100 according to one embodiment of the present invention may be manufactured such that the bearing sleeve 110, the bearing pad 120, and the bearing web 130 are integrally formed through the 3D printing, which is the metal stacking manufacturing scheme.

Accordingly, the externally pressurized journal bearing 100 may have high high-temperature stability, and may be prevented from being deformed.

Meanwhile, the externally pressurized journal bearing 100 according to one embodiment of the present invention may further include a working fluid supply line.

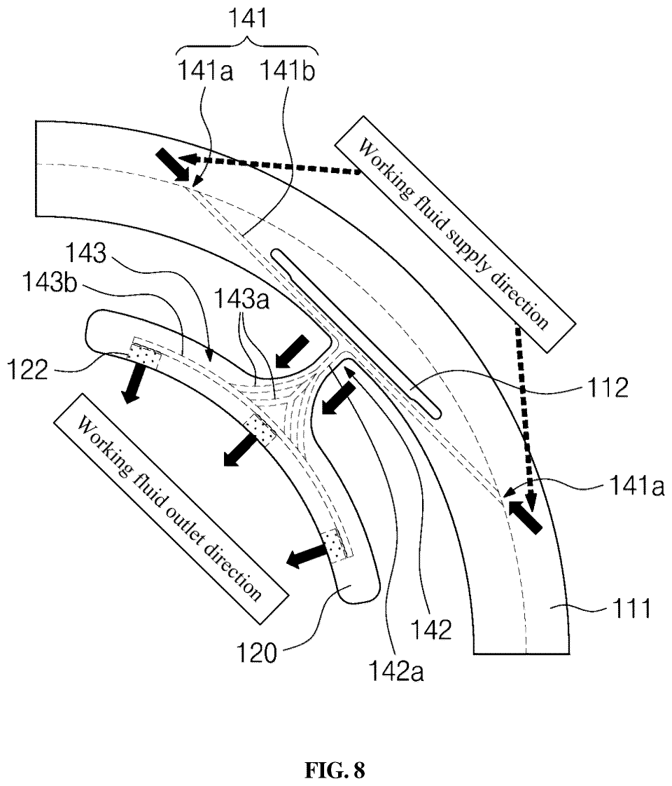

Referring to FIG. 8, the working fluid supply line may provide a movement path for the working fluid (arrow) supplied to a side of an outer diameter surface of the bearing sleeve 110, sequentially passing through the bearing sleeve 110, the bearing web 130, the bearing pad 120, and the porous component 122, and discharged at high pressure toward the rotating shaft S of the rotary machine.

According to one embodiment of the present invention, the working fluid supply line may include a first supply line 141, a second supply line 142, and a third supply line 143.

The first supply line 141 may be one side portion of the working fluid supply line, and may be provided inside the bearing sleeve 110.

Based on a direction in which the working fluid moves, the first supply line 141 may be an upstream side portion of the working fluid supply line.

According to one embodiment of the present invention, the first supply line 141 may include a pocket 141a and a first fluid passage 141b.

The pocket 141a may be formed on an outer diameter surface of the sleeve body 111 forming an exterior of the bearing sleeve 110. The pocket 141a may be formed in the depthwise direction from the outer diameter surface of the sleeve body 111.

The working fluid may be initially supplied to the pocket 141a formed in the depthwise direction on the outer diameter surface of the sleeve body 111 as described above.

According to one embodiment of the present invention, the working fluid may be supplied to one bearing pad 120 through a pair of pockets 141a.

Accordingly, since four bearing pads 120 are provided in one embodiment of the present invention, eight pockets 141a constituting four pairs may be formed in the circumferential direction on the outer diameter surface of the sleeve body 111.

The first fluid passage 141b may be formed inside the sleeve body 111. The first fluid passage 141b may be provided in the form of a hollow bar extending in one direction.

Both longitudinal side end portions of the first fluid passage 141b may be connected to the pockets 141a on both sides. In addition, a second fluid passage 142a of the second supply line 142 may be connected to one longitudinal side of the first fluid passage 141b.

Accordingly, the working fluid supplied to the pockets 141a on the both sides may be provided to the second fluid passage 142a of the second supply line 142 via the first fluid passage 141b.

According to one embodiment of the present invention, the first fluid passage 141b may be provided to correspond to each of the bearing pads 120. For example, when four bearing pads 120 are provided in the circumferential direction on a side of the inner diameter surface of the sleeve body 111, four first fluid passages 141b may be provided inside the sleeve body 111 in the circumferential direction in a one-to-one correspondence with the bearing pads 120.

The second supply line 142 may be provided inside the bearing web 130. Accordingly, the second supply line 142 may be connected between the first supply line 141 provided inside the bearing sleeve 110 and the third supply line 143 provided inside the bearing pad 120.

According to one embodiment of the present invention, the second supply line 142 may include a second fluid passage 142a.

One longitudinal end of the second fluid passage 142a may be connected to the first fluid passage 141b of the first supply line 141. In addition, an opposite longitudinal end of the second fluid passage 142a may be connected to a third-first fluid passage 143a of the third supply line 143, which will be described below, provided inside the bearing pad 120.

The second fluid passage 142a may, for example, branch from one longitudinal side of the first fluid passage 141b toward the third-first fluid passage 143a of the third supply line 143.

In this case, the second fluid passage 142a may be provided inside each of the bearing webs 130 connected to the bearing pads 120, respectively, the bearing pads 120 being arranged in the circumferential direction on an inner diameter side of the bearing sleeve 110.

The third supply line 143 may be provided inside the bearing pad 120. The third supply line 143 may connect the second supply line 142 to the porous component 122.

According to one embodiment of the present invention, the third supply line 143 may be an opposite side portion of the working fluid supply line. Based on the direction in which the working fluid moves, the third supply line 143 may be a downstream side portion of the working fluid supply line.

The third supply line 143 may include a third-first fluid passage 143a and a third-second fluid passage 143b.

The third-first fluid passage 143a may be provided inside the bearing pad 120. A plurality of third-first fluid passages 143a may branch from a longitudinal end of the second fluid passage 142a.

A plurality of third-first fluid passages 143a may branch from the longitudinal end of the second fluid passage 142a in the form as shown in FIG. 8 or in the form as shown in FIG. 9.

The third-second fluid passage 143b may be provided inside the bearing pad 120. The third-second fluid passage 143b may be connected between a rear end of the porous component 122 and longitudinal ends of the branching third-first fluid passages 143a.

According to one embodiment of the present invention, the third-second fluid passage 143b may extend in a surface direction of the bearing pad 120. In other words, the third-second fluid passage 143b may be formed as a space having a shape corresponding to the bearing pad 120.

As described above, when the third-second fluid passage 143b is formed as one large integrated space rather than in the conventional form of a pipe, a sufficient working fluid may be simultaneously supplied to the porous component 122 provided on the at least one side of the bearing pad 120.

In other words, when the third-second fluid passage 143b is formed as one large integrated space, a path for the working fluid introduced into the first supply line 141 to reach the final porous component 122 may be shortened, so that a pressure loss of the working fluid may be reduced to an extent that the path is shortened, and thus a sufficient working fluid may be supplied to the porous component 122.

According to one embodiment of the present invention, the working fluid introduced into the pocket 141a may sequentially pass through the first fluid passage 141b, the second fluid passage 142a, and the third-first fluid passage 143a, and may be supplied to the third-second fluid passage 143b.

The working fluid supplied to the third-second fluid passage 143b may be introduced into the porous component 122, guided to the bearing surface 121 through the porous component 122, and discharged at high pressure from the bearing surface 121 toward the rotating shaft S of the rotary machine by the porous component 122.

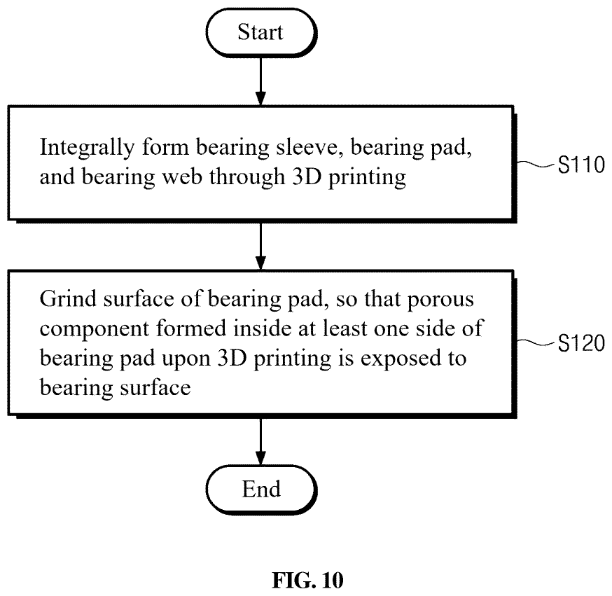

Hereinafter, a method of manufacturing an externally pressurized journal bearing according to one embodiment of the present invention will be described with reference to FIG. 10. In this case, reference numerals of components will be given with reference to FIGS. 1 to 9.

FIG. 10 is a flowchart showing a method of manufacturing an externally pressurized journal bearing according to one embodiment of the present invention.

Referring to FIG. 10, a method of manufacturing an externally pressurized journal bearing according to one embodiment of the present invention may include a step S110 and a step S120.

### Step S110

The step S110 may be a step of integrally forming a bearing sleeve 110, a bearing pad 120, and a bearing web 130.

According to one embodiment of the present invention, in the step S110, the bearing sleeve 110, the bearing pad 120, and the bearing web 130 may be integrally formed through 3D printing, which is a metal stacking manufacturing scheme.

In this case, in the step S110, a porous component 122 may be formed inside at least one side of the bearing pad 120 by controlling energy density to be lower than reference energy density.

In other words, in the step S110, while the bearing sleeve 110 and bearing web 130 are formed with the reference energy density, when a time point to form the porous component 122 having a porous structure comes, the energy density may be lowered, so that the porous component 122 having the porous structure may be formed inside the at least one side of the bearing pad 120.

In this case, the reference energy density may be 35.3 J/mm³ to 37.49 J/mm³, and the energy density for forming the porous component 122 having the porous structure may be 5 J/mm³ to 13 J/mm³, preferably 11 J/mm³ to 13 J/mm³.

To this end, in the step S110, a scanning speed may be controlled to 2,800 mm/s to 6,200 mm/s, and a laser power may be controlled to 160 J/s to 180 J/s.

### Step S120

The step S120 may be a step of grinding a surface of the bearing pad 120.

The porous component 122 may be formed inside the bearing pad 120 through the step S110. In this case, in order for a working fluid to be discharged at high pressure toward a rotating shaft S of a rotary machine, the porous component 122 has to communicate with an outside.

Accordingly, in the step S120, the surface of the bearing pad 120 may be ground, so that the porous component 122 formed inside the at least one side of the bearing pad 120 upon the 3D printing may be exposed to a bearing surface 121.

As described above, when the step S120 is completed, an externally pressurized journal bearing 100 in which the bearing sleeve 110, the bearing pad 120, and the bearing web 130 are integrally formed, and the porous component 122 having the porous structure is provided on the at least one side of the bearing pad 120 may be manufactured.

### Example 1

In order to test a porous component, 20 samples were manufactured under conditions of a scanning speed of 2,800 mm/s to 4,600 mm/s, a hatch distance of 0.105 mm, a laser power of 140 J/s and 180 J/s, energy density of 6 J/mm³ to 13 J/mm³, and a layer thickness of 50 μm, and detailed conditions were shown in Table 1 below.

TABLE 1

| Sam- | Po- | Layer | Hatch | Scanning | Energy | |
|---|---|---|---|---|---|---|
| ple | wer | thickness | distance | speed | density | Weight |
| No. | (J/s) | (μm) | (mm) | (mm/s) | (J/mm³) | (g) |
| 1 | 180 | 50 | 0.105 | 2800 | 12.24 | 6.035 |
| 2 | 180 | 50 | 0.105 | 3000 | 11.43 | 4.915 |
| 3 | 180 | 50 | 0.105 | 3200 | 10.71 | Fail |
| 4 | 180 | 50 | 0.105 | 3400 | 10.8 | Fail |
| 5 | 180 | 50 | 0.105 | 3600 | 9.52 | Fail |
| 6 | 180 | 50 | 0.105 | 3800 | 9.02 | Fail |
| 7 | 180 | 50 | 0.105 | 4000 | 8.57 | Fail |
| 8 | 180 | 50 | 0.105 | 4200 | 8.16 | Fail |
| 9 | 180 | 50 | 0.105 | 4400 | 7.79 | 9.521 |
| 10 | 180 | 50 | 0.105 | 4600 | 7.45 | 8.996 |
| 11 | 140 | 50 | 0.105 | 2200 | 12.12 | Fail |
| 12 | 140 | 50 | 0.105 | 2400 | 11.11 | Fail |
| 13 | 140 | 50 | 0.105 | 2600 | 10.26 | Fail |
| 14 | 140 | 50 | 0.105 | 2800 | 9.52 | Fail |
| 15 | 140 | 50 | 0.105 | 3000 | 8.89 | Fail |
| 16 | 140 | 50 | 0.105 | 3200 | 8.33 | Fail |
| 17 | 140 | 50 | 0.105 | 3400 | 7.84 | Fail |
| 18 | 140 | 50 | 0.105 | 3600 | 7.41 | Fail |
| 19 | 140 | 50 | 0.105 | 3800 | 7.02 | Fail |
| 20 | 140 | 50 | 0.105 | 4000 | 6.67 | Fail |

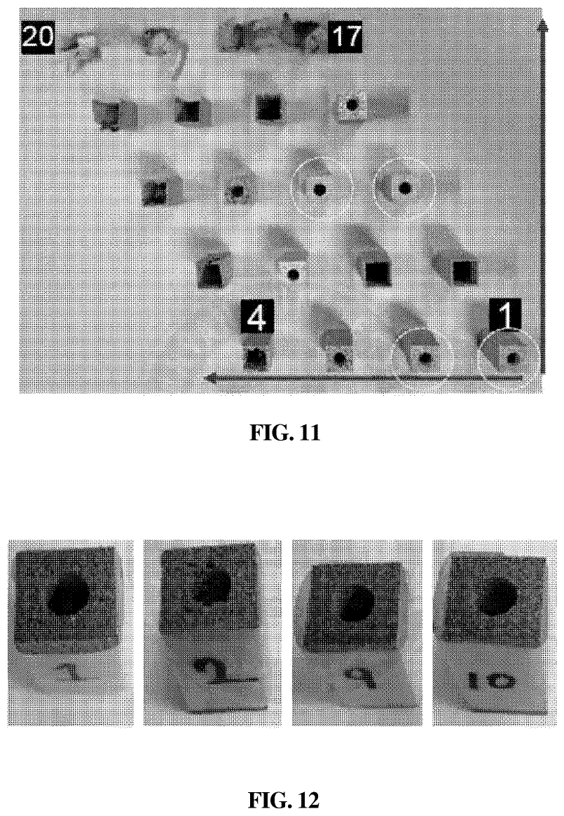

Referring to FIGS. 11 and 12 and Table 1 above, among a total of 20 samples manufactured according to Example 1, a porous structure was formed only in Samples 1, 2, 9, and 10 in which the laser power was controlled to 180 J/s.

### Example 2

20 samples were manufactured under conditions of a scanning speed of 4,000 mm/s to 6,200 mm/s, a hatch distance of 0.105 mm, a laser power of 160 J/s and 180 J/s, energy density of 5 J/mm³ to 8 J/mm³, and a layer thickness of 50 μm, and detailed conditions were shown in Table 2 below.

TABLE 2

| Sam- | Po- | Layer | Hatch | Scanning | Energy | |
|---|---|---|---|---|---|---|
| ple | wer | thickness | distance | speed | density | Weight |
| No. | (J/s) | (μm) | (mm) | (mm/s) | (J/mm³) | (g) |
| 1 | 180 | 50 | 0.105 | 4400 | 7.79 | 9.491 |
| 2 | 180 | 50 | 0.105 | 4600 | 7.45 | 9.353 |
| 3 | 180 | 50 | 0.105 | 4800 | 7.14 | 8.392 |
| 4 | 180 | 50 | 0.105 | 5000 | 6.86 | 8.335 |
| 5 | 180 | 50 | 0.105 | 5200 | 6.59 | 9.099 |
| 6 | 180 | 50 | 0.105 | 5400 | 6.35 | 7.513 |
| 7 | 180 | 50 | 0.105 | 5600 | 6.12 | Fail |
| 8 | 180 | 50 | 0.105 | 5800 | 5.91 | 5.871 |
| 9 | 180 | 50 | 0.105 | 6000 | 5.71 | 7.358 |
| 10 | 180 | 50 | 0.105 | 6200 | 5.53 | 4.827 |
| 11 | 160 | 50 | 0.105 | 4000 | 7.62 | Fail |
| 12 | 160 | 50 | 0.105 | 4200 | 7.26 | Fail |
| 13 | 160 | 50 | 0.105 | 4400 | 6.93 | 8.529 |
| 14 | 160 | 50 | 0.105 | 4600 | 6.63 | 7.961 |
| 15 | 160 | 50 | 0.105 | 4800 | 6.35 | 6.573 |
| 16 | 160 | 50 | 0.105 | 5000 | 6.1 | 7.017 |
| 17 | 160 | 50 | 0.105 | 5200 | 5.86 | 6.554 |
| 18 | 160 | 50 | 0.105 | 5400 | 5.64 | 5.039 |
| 19 | 160 | 50 | 0.105 | 5600 | 5.44 | 4.864 |
| 20 | 160 | 50 | 0.105 | 5800 | 5.25 | Fail |

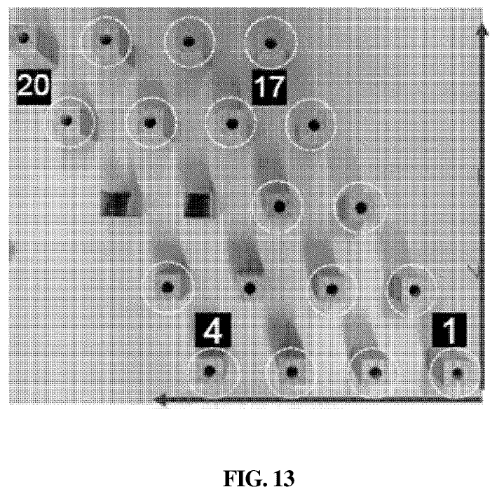

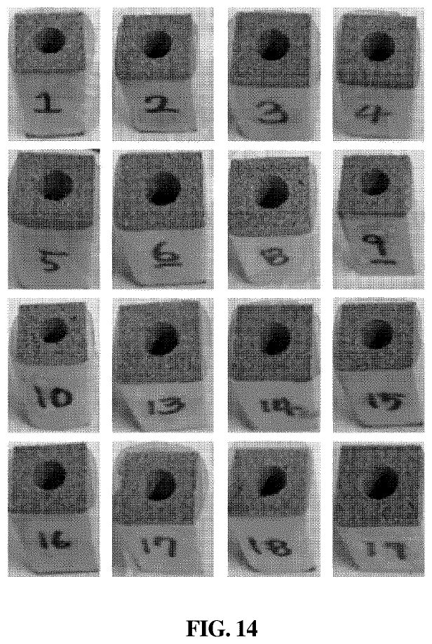

Referring to FIGS. 13 and 14 and Table 2 above, among a total of 20 samples manufactured according to Example 2, a porous structure was formed in Samples 1 to 6 and Samples 8 to 10, excluding Sample 7, under the condition that the laser power was controlled to 180 J/s, and a porous structure was formed in Samples 13 to 19, excluding Samples 11, 12, and 20, under the condition that the laser power was controlled to 160 J/s.

A one-touch fitting was assembled to Samples 1, 2, 9, and 10 of Example 1 in which the porous structure was formed so as to perform a working fluid pressurization test, and results thereof were shown in Table 3 below.

TABLE 3

| | Energy | Supply | Supply | Supply |
|---|---|---|---|---|
| | density | pressure | pressure | pressure |
| Sample No. | (J/mm³) | 1 bar (g) | 2 bar (g) | 3 bar (g) |
| 1 | 12.24 | 186 L/min | 271 L/min | — |
| 2 | 11.43 | 185 L/min | 268 L/min | — |
| 9 | 7.79 | 48 L/min | 82 L/min | 116 L/min |
| 10 | 7.45 | 67 L/min | 104 L/min | 149 L/min |

As shown in Table 3 above, it was found that the porous component has a relatively large flow rate under identical supply pressure of a working fluid as the energy density increases.

In addition, the one-touch fitting was assembled to Samples 1 to 6, 13, and 14 among Samples 1 to 6, Samples 8 to 10, and Samples 13 to 19 of Example 2 in which the porous structure was formed so as to perform the working fluid pressurization test, and results thereof were shown in Table 4 below.

TABLE 4

| | Energy | Supply | Supply | Supply |
|---|---|---|---|---|
| Sample | density | pressure | pressure | pressure |
| No. | (J/mm³) | 1 bar (g) | 2 bar (g) | 3 bar (g) |
| 1 | 7.79 | 59 L/min | 95 L/min | 137 L/min |
| 2 | 7.45 | 59 L/min | 96 L/min | 138 L/min |
| 3 | 7.14 | 80 L/min | 121 L/min | 162 L/min |
| 4 | 6.86 | 82 L/min | 123 L/min | 164 L/min |
| 5 | 6.59 | 63 L/min | 101 L/min | 146 L/min |
| 6 | 6.35 | 87 L/min | 126 L/min | 164 L/min |
| 13 | 6.93 | 76 L/min | 119 L/min | 162 L/min |
| 14 | 6.63 | 85 L/min | 126 L/min | 164 L/min |

As shown in Tables 3 and 4 above, it was found that the samples having energy density of 11 J/mm³ or more have flow rates that are at least twice as large as flow rates of the samples having formation energy density of 8 J/mm³ or less under the identical supply pressure of the working fluid.

While it was found that the conditions applied to Example 2 were superior to the conditions applied to Example 1 in forming the porous structure, it was found that the samples manufactured according to Example 2 (energy density of 8 J/mm³ or less) have relatively lower flow rates according to the supply pressure than Samples 1 and 2 manufactured according to Example 1 (energy density of 11 J/mm³ or more).

Although the exemplary embodiments of the present invention have been described in detail above, the scope of the present invention is not limited to a specific embodiment, and shall be interpreted by the appended claims. In addition, it is to be understood by a person having ordinary skill in the art that various changes and modifications can be made without departing from the scope of the present invention.

1. An externally pressurized journal bearing comprising:
a bearing sleeve mounted in a ring-engaged manner on an outer diameter surface of a rotating shaft;
a plurality of bearing pads provided on an inner diameter surface of the bearing sleeve, arranged with a gap in a circumferential direction on the inner diameter surface of the bearing sleeve, and configured to support the rotating shaft in a radial direction through a bearing surface facing the rotating shaft; and
a bearing web provided between the bearing sleeve and the bearing pad, formed integrally with the bearing sleeve and the bearing pad, and having flexibility so as to enable tilting of the bearing pad,
wherein at least one side of the bearing pad is provided as a porous component, and
a working fluid supplied from a side of the bearing sleeve side and passing through the bearing sleeve and the bearing web is guided to the bearing surface through the porous component, and discharged at high pressure from the bearing surface toward the rotating shaft by the porous component.

2. The externally pressurized journal bearing of claim 1, wherein formation energy density of the porous component is 5 J/mm³ to 13 J/mm³.

3. The externally pressurized journal bearing of claim 2, wherein, under identical supply pressure of the working fluid, in a case where the formation energy density is greater or equal to 11 J/mm³, the porous component has a flow rate that is at least twice as large as a flow rate in a case where the formation energy density is greater or equal to 8 J/mm³.

4. The externally pressurized journal bearing of claim 2, wherein the formation energy density of the porous component is 11 J/mm³ to 13 J/mm³.

5. The externally pressurized journal bearing of claim 4, wherein the porous component has a relatively large flow rate under identical supply pressure of the working fluid as the formation energy density increases.

6. The externally pressurized journal bearing of claim 1, wherein the bearing sleeve includes:
a sleeve body having a center that is open in an axial direction so as to allow insertion of the rotating shaft; and
a slot provided inside the sleeve body so as to correspond to each of the bearing pads, and configured to allow both axial ends of the sleeve body to communicate with each other.

7. The externally pressurized journal bearing of claim 6, further comprising:
a damper,
wherein the damper is installed in the slot, and configured to support the bearing pad in the radial direction.

8. The externally pressurized journal bearing of claim 1, further comprising:
a working fluid supply line,
wherein the working fluid supply line includes:
a first supply line provided inside the bearing sleeve;
a second supply line connected to the first supply line, and provided inside the bearing web; and
a third supply line provided inside the bearing pad, and connecting the second supply line to the porous component.

9. The externally pressurized journal bearing of claim 8, wherein the first supply line includes:
a pocket formed on an outer diameter surface of the bearing sleeve; and
a first fluid passage connected to the pocket, extending in one direction, and provided to correspond to each of the bearing pads.

10. The externally pressurized journal bearing of claim 9, wherein the second supply line includes a second fluid passage branching from one longitudinal side of the first fluid passage toward the third supply line.

11. The externally pressurized journal bearing of claim 10, wherein the third supply line includes:
a plurality of third-first fluid passages branching from a longitudinal end of the second fluid passage; and
a third-second fluid passage extending in a surface direction of the bearing pad, and connected between a rear end of the porous component and longitudinal ends of the branching third-first fluid passages.

12. A method of manufacturing an externally pressurized journal bearing, the method comprising:
integrally forming, through 3D printing, a bearing sleeve mounted in a ring-engaged manner on an outer diameter surface of a rotating shaft, a plurality of bearing pads provided on an inner diameter surface of the bearing sleeve, arranged with a gap in a circumferential direction on the inner diameter surface of the bearing sleeve, and configured to support the rotating shaft in a radial direction through a bearing surface facing the rotating shaft, and a bearing web provided between the bearing sleeve and the bearing pad, and having flexibility so as to enable tilting of the bearing pad,
wherein, in the integrally forming, a porous component is formed on at least one side of the bearing pad by controlling energy density to be lower than reference energy density.

13. The method of claim 12, wherein formation energy density of the porous component is 5 J/mm³ to 13 J/mm³.

14. The method of claim 13, wherein, in the integrally forming, a scanning speed is controlled to 2,800 mm/s to 6,200 mm/s, and a laser power is controlled to 160 J/s to 180 J/s.
